(19) United States
(12) Patent Application Publication
(10) Pub. No.: US 2025/0067593 A1
(43) Pub. Date: Feb. 27, 2025

(54) NOISE SUPPRESSION APPARATUS, NOISE SUPPRESSION METHOD, AND NON-TRANSITORY COMPUTER-READABLE MEDIUM

(71) Applicant: NEC Corporation, Tokyo (JP)

(72) Inventors: Noriyuki TONAMI, Tokyo (JP); Sakiko MISHIMA, Tokyo (JP); Yumi ARAI, Tokyo (JP); Reishi KONDO, Tokyo (JP); Tomoyuki HINO, Tokyo (JP)

(73) Assignee: NEC CORPORATION, tOKYO (JP)

(21) Appl. No.: 18/801,970

(22) Filed: Aug. 13, 2024

(30) Foreign Application Priority Data
Aug. 24, 2023 (JP) 2023-136007

(51) Int. Cl. G01H 9/00; H04R 23/00

(52) U.S. Cl. CPC G01H 9/004; H04R 23/008

(57) ABSTRACT

A noise suppression apparatus according to the present disclosure includes at least one memory configured to store instructions, and at least one processor configured, by executing the instructions, to input a plurality of noise superimposed signals that are acquired by distributed acoustic sensing (DAS) using an optical fiber cable and on which noise is superimposed, extract a common feature of the plurality of input noise superimposed signals as a noise suppression signal in which noise is suppressed, and output the extracted noise suppression signal.

### INCORPORATION BY REFERENCE

This application is based upon and claims the benefit of priority from Japanese patent application No. 2023-136007, filed on Aug. 24, 2023, the disclosure of which is incorporated herein in its entirety by reference.

### TECHNICAL FIELD

The present disclosure relates to a noise suppression apparatus, a noise suppression method, and a non-transitory computer-readable medium.

### BACKGROUND ART

Distributed acoustic sensing (DAS) is one of optical fiber sensing techniques using an optical fiber cable, and is capable of detecting sound and vibration occurred at a point on the optical fiber cable.

Further, it is also possible to acquire a DAS signal indicating sound or vibration detected by the DAS, and recognize an event such as an abnormality occurred at a point on the optical fiber cable, based on the acquired DAS signal.

However, a DAS signal is a noise superimposed signal on which noise is superimposed. Thus, in order to recognize an event by using such a noise superimposed signal, it is necessary to suppress the noise of the noise superimposed signal. As a noise suppression method for suppressing noise of a noise superimposed signal, for example, a method referred to as spectral subtraction described in Japanese Unexamined Patent Application Publication No. H10-149191 is cited.

### SUMMARY

As described above, as a noise suppression method, there is a method referred to as spectral subtraction described in Japanese Unexamined Patent Application Publication No. H10-149191.

However, a noise suppression effect may be insufficient only by using an existing noise suppression method such as spectral subtraction. Thus, a technique being capable of further suppressing noise of a noise superimposed signal has recently been desired.

Thus, in view of the problem described above, an example object of the present disclosure is to provide a noise suppression apparatus, a noise suppression method, and a non-transitory computer-readable medium that are capable of further suppressing noise of a noise superimposed signal.

In a first example aspect, a noise suppression apparatus according to the present disclosure includes:
at least one memory configured to store instructions; and
at least one processor configured, by executing the instructions, to input a plurality of noise superimposed signals that are acquired by distributed acoustic sensing (DAS) using an optical fiber cable and on which noise is superimposed, extract a common feature of the plurality of input noise superimposed signals as a noise suppression signal in which noise is suppressed, and output the extracted noise suppression signal.

In a second example aspect, a noise suppression method according to the present disclosure is a noise suppression method executed by a noise suppression apparatus, the noise suppression method includes:
inputting a plurality of noise superimposed signals that are acquired by distributed acoustic sensing (DAS) using an optical fiber cable and on which noise is superimposed;
extracting a common feature of the plurality of noise superimposed signals as a noise suppression signal in which noise is suppressed; and
outputting the noise suppression signal.

In a third example aspect, a non-transitory computer-readable medium according to the present disclosure stores a program causing a computer to execute:
a procedure of inputting a plurality of noise superimposed signals that are acquired by distributed acoustic sensing (DAS) using an optical fiber cable and on which noise is superimposed;
a procedure of extracting a common feature of the plurality of noise superimposed signals as a noise suppression signal in which noise is suppressed; and
a procedure of outputting the noise suppression signal.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a diagram illustrating a configuration example of a noise suppression apparatus according to the present disclosure;

FIG. 2 is a diagram illustrating a configuration example of a common feature extractor according to the present disclosure;

FIG. 3 is a diagram illustrating a schematic operation example of the common feature extractor according to the present disclosure;

FIG. 4 is a diagram illustrating an example of a noise suppression effect by the noise suppression apparatus according to the present disclosure;

FIG. 5 is a diagram illustrating an example of a method of expressing a DAS signal;

FIG. 6 is a diagram illustrating an example in which Tucker decomposition is applied to a DAS signal;

FIG. 7 is a diagram illustrating an example of an intuitive image of the present disclosure;

FIG. 8 is a diagram illustrating a configuration example of the noise suppression apparatus according to the present disclosure;

FIG. 9 is a flowchart illustrating a schematic operation example of the noise suppression apparatus according to the present disclosure; and

FIG. 10 is a block diagram illustrating a hardware configuration example of a computer that achieves the noise suppression apparatus according to the present disclosure.

### EXAMPLE EMBODIMENT

Hereinafter, example embodiments of the present disclosure will be described with reference to the drawings. Note that, the following description and the drawings are omitted and simplified as appropriate for clarity of description. Further, in each of the following drawings, the same elements are denoted by the same reference signs, and redundant descriptions are omitted as necessary. Further, a specific numerical value and the like indicated in the following description and drawings is merely an example for facilitating understanding of the present disclosure, and is not limited thereto.

### First Example Embodiment

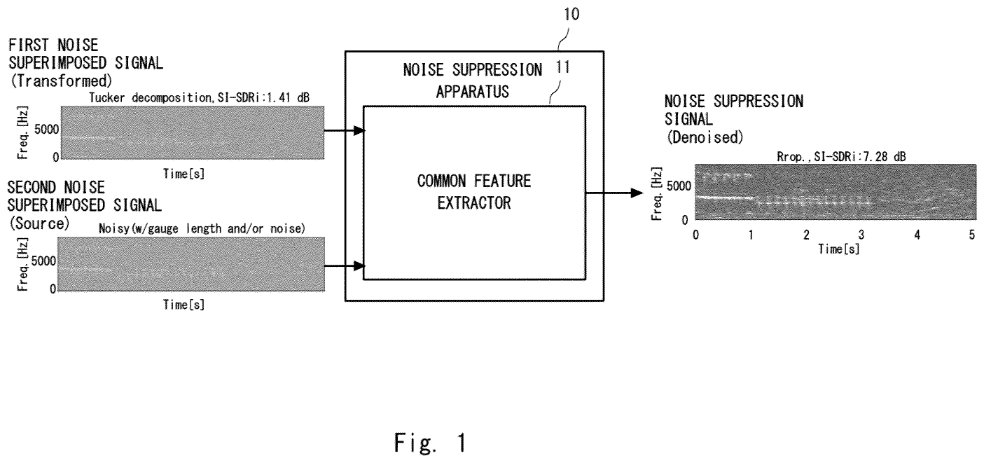

First, a configuration example of a noise suppression apparatus 10 will be described with reference to FIG. 1.

As illustrated in FIG. 1, the noise suppression apparatus 10 includes a common feature extractor 11.

Herein, it is assumed that a DAS apparatus not being illustrated connects to an optical fiber cable, detects sound and vibration occurred at a point on the optical fiber cable by the DAS using the optical fiber cable, and acquires a DAS signal indicating the detected sound or vibration. Further, it is assumed that the DAS signal is a signal indicating a time change in a frequency of sound or vibration occurred at any point on the optical fiber cable and detected by the DAS.

Further, it is assumed that an optical fiber cable not being illustrated is laid outdoors or indoors. When the optical fiber cable is laid outdoors, it is assumed that the optical fiber cable is laid, for example, in such a manner that it is suspended in a pole such as a utility pole or buried in the ground. Further, when the optical fiber cable is laid indoors, it is assumed that the optical fiber cable is laid under a mat or a carpet, for example.

Further, it is assumed that the DAS apparatus or a processing apparatus not being illustrated performs processing of transforming a DAS signal acquired by the DAS apparatus by a predetermined noise suppression method, that is, processing of suppressing noise of the DAS signal by the predetermined noise suppression method. Further, it is assumed that the predetermined noise suppression method is, for example, a method such as spectral subtraction, Wiener filtering, or singular value decomposition. Note that, since these noise suppression methods are known techniques, the description thereof will be omitted.

The common feature extractor 11 inputs a DAS signal from a DAS apparatus not being illustrated, as a second noise superimposed signal on which noise is superimposed.

Further, the common feature extractor 11 inputs a signal acquired by transforming a DAS signal by a predetermined noise suppression method, that is, a signal acquired by suppressing noise of the DAS signal by the predetermined noise suppression method, from a DAS apparatus or a processing apparatus not being illustrated, as a first noise superimposed signal on which noise is superimposed.

The common feature extractor 11 extracts a common feature of the input first noise superimposed signal and the input second noise superimposed signal as a noise suppression signal in which noise is suppressed, and outputs the extracted noise suppression signal.

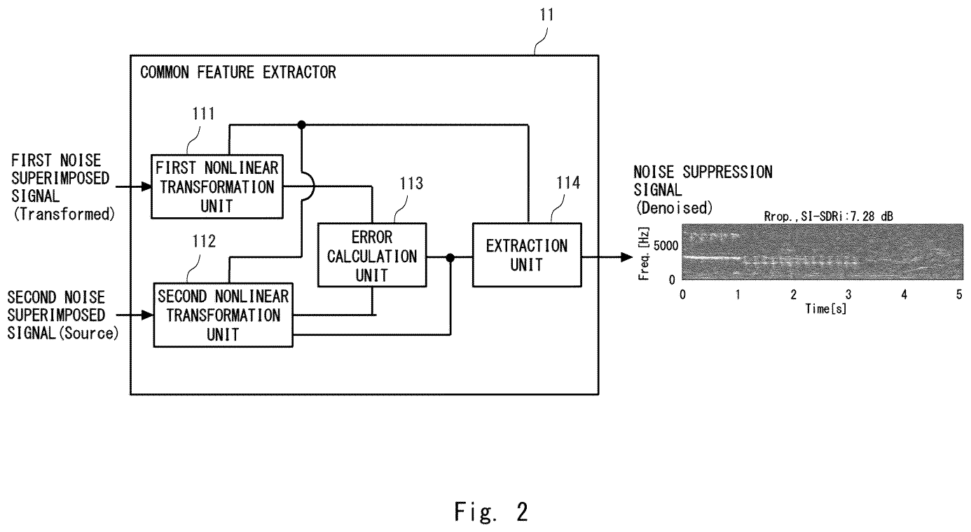

Subsequently, a configuration example of the common feature extractor 11 will be described with reference to FIG. 2.

As illustrated in FIG. 2, the common feature extractor 11 includes a first nonlinear transformation unit 111, a second nonlinear transformation unit 112, an error calculation unit 113, and an extraction unit 114.

The first nonlinear transformation unit 111 inputs a first noise superimposed signal, and performs nonlinear transformation on the input first noise superimposed signal by using a parameter.

The second nonlinear transformation unit 112 inputs a second noise superimposed signal, and performs nonlinear transformation on the input second noise superimposed signal by using a parameter.

For example, it is assumed that each of the first nonlinear transformation unit 111 and the second nonlinear transformation unit 112 performs nonlinear transformation of Y=aX+b. Under the assumption, a and b are equivalent to the parameters described above.

The error calculation unit 113 calculates an error by using a difference between an output of the first nonlinear transformation unit 111 and an output of the second nonlinear transformation unit 112. In other words, in the first example embodiment, the error calculation unit 113 calculates an error as follows.

Error=Difference between an output of the first nonlinear transformation unit 111 and an output of the second nonlinear transformation unit 112

The extraction unit 114 compares the error calculated by the error calculation unit 113 with a threshold value ε.

As a result of the comparison, when the error is less than the threshold value ε, the extraction unit 114 extracts the output of the second nonlinear transformation unit 112, that is, the second noise superimposed signal subjected to nonlinear transformation by the second nonlinear transformation unit 112, as a noise suppression signal, and outputs the extracted noise suppression signal.

On the other hand, as a result of the comparison, when the error is equal to or greater than the threshold value, the extraction unit 114 updates the parameters of the first nonlinear transformation unit 111 and the second nonlinear transformation unit 112. Then, the extraction unit 114 causes the first nonlinear transformation unit 111 and the second nonlinear transformation unit 112 to perform nonlinear transformation by using the updated parameters, and also causes the error calculation unit 113 to perform error calculation. As a result, when the error is still equal to or greater than the threshold value ε, the extraction unit 114 updates the parameters of the first nonlinear transformation unit 111 and the second nonlinear transformation unit 112 again.

In other words, the extraction unit 114 repeats the updating of the parameters of the first nonlinear transformation unit 111 and the second nonlinear transformation unit 112 until the error becomes less than the threshold value ε. Then, when the error becomes less than the threshold value ε, the extraction unit 114 extracts the output of the second nonlinear transformation unit 112 as a noise suppression signal, and outputs the extracted noise suppression signal.

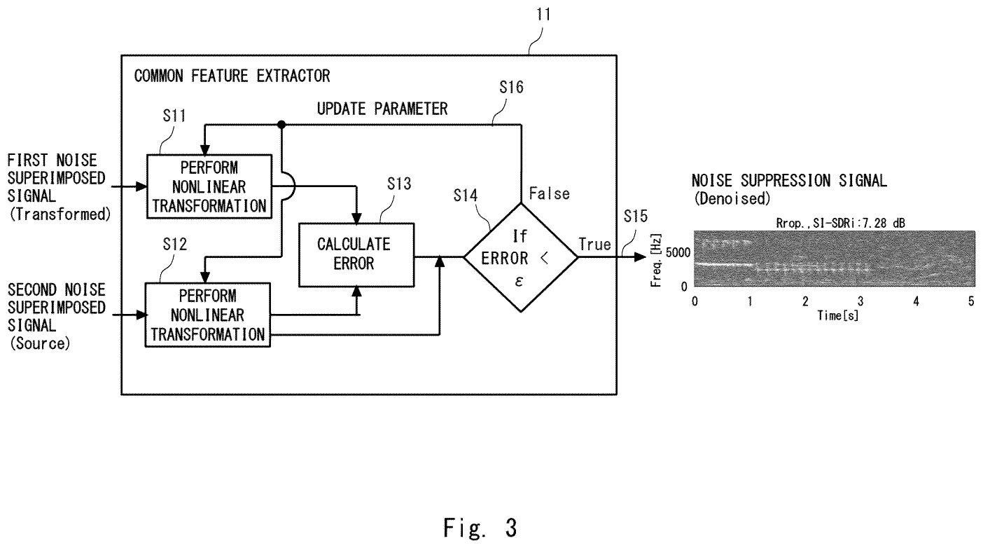

Subsequently, a schematic operation example of the common feature extractor 11 will be described with reference to FIG. 3.

As illustrated in FIG. 3, first, the first nonlinear transformation unit 111 inputs a first noise superimposed signal, and performs nonlinear transformation on the input first noise superimposed signal by using a parameter (step S11). Further, the second nonlinear transformation unit 112 inputs a second noise superimposed signal, and performs nonlinear transformation on the input second noise superimposed signal by using a parameter (step S12).

Next, the error calculation unit 113 calculates an error by using a difference between an output of the first nonlinear transformation unit 111 and an output of the second nonlinear transformation unit 112 (step S13).

Next, the extraction unit 114 compares the error calculated by the error calculation unit 113 with the threshold value ε (step S14).

As a result of the comparison, when the error is less than the threshold value ε (True in step S14), the extraction unit 114 extracts the output of the second nonlinear transformation unit 112, that is, the second noise superimposed signal subjected to nonlinear transformation by the second nonlinear transformation unit 112, as a noise suppression signal, and outputs the extracted noise suppression signal (step S15).

On the other hand, as a result of the comparison, when the error is equal to or greater than the threshold value ε (False in step S14), the extraction unit 114 repeats updating of the parameters of the first nonlinear transformation unit 111 and the second nonlinear transformation unit 112 until the error becomes less than the threshold value ε (step S16). Then, when the error becomes less than the threshold value ε (True in step S14), the extraction unit 114 extracts the output of the second nonlinear transformation unit 112 as a noise suppression signal, and outputs the extracted noise suppression signal (step S15).

As described above, according to the first example embodiment, the common feature extractor 11 extracts a common feature of a first noise superimposed signal and a second noise superimposed signal on which noise is superimposed, as a noise suppression signal in which noise is suppressed. As a result, the common feature extractor 11 can further suppress noise of the second noise superimposed signal (or the first noise superimposed signal). Further, the common feature extractor 11 can suppress noise of the second noise superimposed signal (or the first noise superimposed signal) by using only the first noise superimposed signal and the second noise superimposed signal as an input.

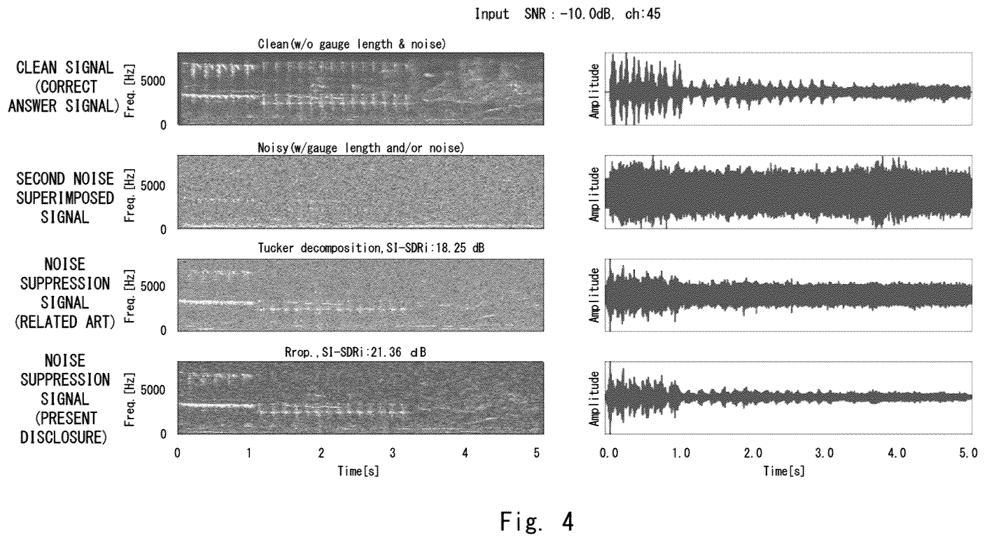

Hereinafter, an example of a noise suppression effect by the noise suppression apparatus 10 will be described with reference to FIG. 4.

FIG. 4 illustrates, in order from the top, a clean signal (correct answer signal) in which noise of a second noise superimposed signal is suppressed by simulation, a second noise superimposed signal, a noise suppression signal in which noise of a second noise superimposed signal is suppressed according to a related art, and a noise suppression signal in which noise of a second noise superimposed signal is suppressed according to the present disclosure. Note that, the noise suppression signal according to the related art at third from the top is a signal acquired by suppressing noise of the second noise superimposed signal by a predetermined noise suppression method, and is equivalent to a first noise superimposed signal. Further, each of four signals on a left side in FIG. 4 is a signal indicating a time change in frequency of sound or vibration occurred at any point on an optical fiber cable and detected by the DAS, and each of four signals on a right side in FIG. 4 is a signal indicating a time change in amplitude of sound or vibration occurred at any point on an optical fiber cable and detected by the DAS.

As illustrated in FIG. 4, the noise suppression signal acquired by suppressing noise of the second noise superimposed signal according to the related art cannot reproduce the clean signal (correct answer signal), and it can be seen that the noise suppression effect is insufficient.

In contrast, the noise suppression signal acquired by suppressing noise of the second noise superimposed signal according to the present disclosure can almost reproduce the clean signal (correct answer signal), and it can be seen that a sufficient noise suppression effect is acquired.

Note that, in the first example embodiment, the noise suppression apparatus 10 inputs two noise superimposed signals, i.e., a first noise superimposed signal and a second noise superimposed signal, but the number of the input noise superimposed signals is not limited to two. The noise suppression apparatus 10 may be a configuration to be input a plurality of noise superimposed signals.

Further, the noise suppression apparatus 10 inputs the second noise superimposed signal, and the first noise superimposed signal acquired by suppressing noise of the second noise superimposed signal by a predetermined noise suppression method, but a type of the input noise superimposed signal is not limited to this. For example, the noise suppression apparatus 10 may be a configuration to be input a plurality of noise superimposed signals acquired by the DAS with respect to sound or vibration occurred in the same region by using optical fiber cables different from each other.

### Second Example Embodiment

A second example embodiment is different as compared with the first example embodiment in that a common feature extractor 11 extracts a common feature of a first noise superimposed signal and a second noise superimposed signal as a noise suppression signal, in consideration of a spatial feature around an optical fiber cable. Note that, since a configuration itself of the second example embodiment is similar to that of the first example embodiment described above, the description thereof will be omitted.

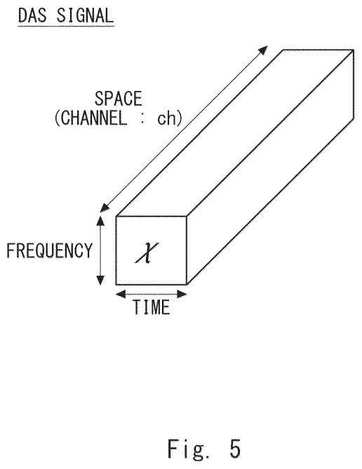

First, with reference to FIG. 5, an example of a method of expressing a DAS signal that can be acquired by DAS will be described.

As illustrated in FIG. 5, the DAS signal can be expressed as a third rank tensor, that is, as space (a channel), a time, and a frequency. Herein, the channel is each point at which sensing on an optical fiber cable is performed. Thus, the space includes a large number of channels.

Thus, the spatial feature around the optical fiber cable includes the following.

### (1) Low Ranking of a Spatial Dimension of the DAS Signal

In other words, the number of sound sources or the number of vibration sources is smaller with respect to the number of channels on the optical fiber cable.

### (2) Non-Uniformity of Sensitivity Between Channels on the Optical Fiber Cable

In other words, there is a difference in a signal-to-noise ratio (SNR) with respect to the DAS signal between each of the channels on the optical fiber cable.

Thus, in consideration of the above-described (1) and (2), the common feature extractor 11 performs the following processing in order to extract a common feature of a first noise superimposed signal and a second noise superimposed signal as a noise suppression signal.

### (1) Low Ranking of a Spatial Dimension of the DAS Signal

Each of a first nonlinear transformation unit 111 and a second nonlinear transformation unit 112 performs nonlinear transformation with a low rank constraint in a spatial dimension on the first noise superimposed signal and the second noise superimposed signal.

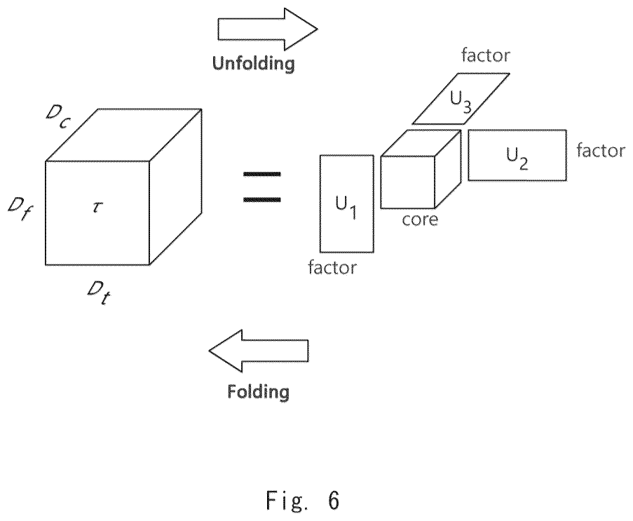

Herein, in order to describe the above-described processing of the first nonlinear transformation unit 111 and the second nonlinear transformation unit 112, an example in which Tucker decomposition is applied to the DAS signal will be described with reference to FIG. 6.

Tucker decomposition is one example of tensor decomposition, and a method in which a given tensor is decomposed (unfolding) into a low-rank core tensor (core) and factor matrix (factor) by using a rank given in advance.

As illustrated in FIG. 6, in a case of the DAS signal, the number of ranks given in advance to each tensor of space (a channel), a time, and a frequency is set as follows.

Time: Rₜ, Frequency: R_{f}, Channel: R_{c}

Further, the number of ranks of an original DAS signal is set as follows.

Time: Dₜ, Frequency: D_{f}, Channel: D_{c}

As described above, since the spatial dimension of the DAS signal is a low rank, D_{c} and R_{c} are considered to be in the following relation.

R_{c}>=D_{c}

The above-described low rank constraint of the spatial dimension is equivalent to an operation (folding) of returning to a size of an original tensor by multiplying a low-rank core tensor (i.e., space (channel)) and a factor matrix together.

In other words, each of the first nonlinear transformation unit 111 and the second nonlinear transformation unit 112 performs the above-described operation (folding) on the first noise superimposed signal and the second noise superimposed signal, respectively, and then performs nonlinear transformation.

### (2) Non-Uniformity of Sensitivity Between Channels on the Optical Fiber Cable

An error calculation unit 113 calculates an error by using a regularization term taking into consideration a difference in sensitivity between the channels on the optical fiber cable, while using a difference between an output of the first nonlinear transformation unit 111 and an output of the second nonlinear transformation unit 112. In other words, in the second example embodiment, the error calculation unit 113 calculates an error as follows.

Error=Difference between an output of the first nonlinear transformation unit 111 and an output of the second nonlinear transformation unit 112+regularization term taking into consideration a difference in sensitivity between the channels on the optical fiber cable

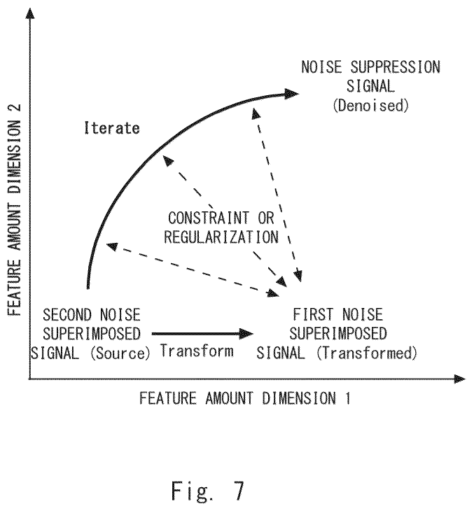

Subsequently, an example of an intuitive image according to the second example embodiment will be described with reference to FIG. 7.

As illustrated in FIG. 7, in the second example embodiment, processing of extracting a noise suppression signal as a common feature of two noise superimposed signals is performed while taking into consideration the low rank constraint and regularization of the spatial dimension in such a way that a second noise superimposed signal is not too far from a first noise superimposed signal.

Note that, operation of the second example embodiment other than the above-described operation is similar to that of the first example embodiment described above, and thus the description thereof is omitted.

As described above, according to the second example embodiment, the common feature extractor 11 extracts a common feature of a first noise superimposed signal and a second noise superimposed signal as a noise suppression signal, in consideration of a spatial feature around an optical fiber cable. As a result, the common feature extractor 11 can further suppress noise of the second noise superimposed signal (or the first noise superimposed signal) as compared with the first example embodiment described above. Another advantageous effect is similar to that of the first example embodiment described above.

### Third Example Embodiment

A third example embodiment is equivalent to an example embodiment in which the first and second example embodiments described above are put into a higher concept.

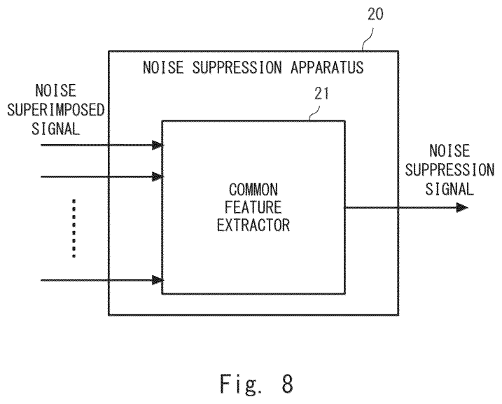

First, a configuration example of a noise suppression apparatus 20 will be described with reference to FIG. 8.

As illustrated in FIG. 8, the noise suppression apparatus 20 includes a common feature extractor 21.

The common feature extractor 21 inputs a plurality of noise superimposed signals that are acquired by DAS using an optical fiber cable and on which noise is superimposed.

Further, the common feature extractor 21 extracts a common feature of the plurality of input noise superimposed signals, as a noise suppression signal in which noise is suppressed.

Further, the common feature extractor 21 outputs the extracted noise suppression signal.

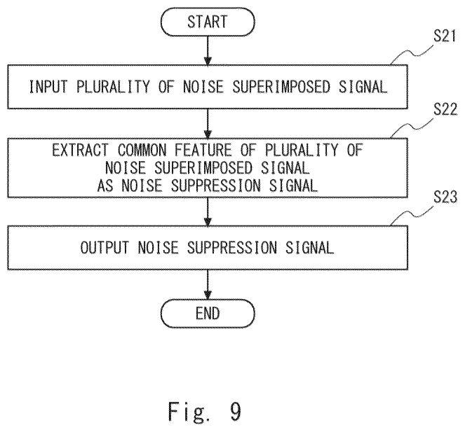

Subsequently, a schematic operation example of the noise suppression apparatus 20 will be described with reference to FIG. 9.

As illustrated in FIG. 9, first, the common feature extractor 21 inputs a plurality of noise superimposed signals that are acquired by the DAS using an optical fiber cable and on which noise is superimposed (step S21). Next, the common feature extractor 21 extracts a common feature of the plurality of input noise superimposed signals, as a noise suppression signal in which noise is suppressed (step S22). Thereafter, the common feature extractor 21 outputs the extracted noise suppression signal (step S23).

As described above, according to the third example embodiment, the common feature extractor 21 extracts a common feature of a plurality of noise superimposed signals on which noise is superimposed, as a noise suppression signal in which noise is suppressed. As a result, the common feature extractor 21 can further suppress noise of the noise superimposed signal. Another advantageous effect is similar to that of the first and second example embodiments described above.

Note that, the common feature extractor 21 may extract a common feature of a plurality of noise superimposed signals as a noise suppression signal, in consideration of a spatial feature around the optical fiber cable.

Further, the plurality of noise superimposed signals may be a first noise superimposed signal and a second noise superimposed signal. In this case, the common feature extractor 21 may include a first nonlinear transformation unit that inputs the first noise superimposed signal and performs nonlinear transformation on the input first noise superimposed signal by using a parameter, a second nonlinear transformation unit that inputs the second noise superimposed signal and performs nonlinear transformation on the input second noise superimposed signal by using a parameter, an error calculation unit that calculates an error by using a difference between an output of the first nonlinear transformation unit and an output of the second nonlinear transformation unit, and an extraction unit that repeatedly updates the parameter until the error becomes less than a threshold value, extracts the output of the first nonlinear transformation unit or the output of the second nonlinear transformation unit, as a noise suppression signal, when the error becomes less than the threshold value, and outputs the extracted noise suppression signal.

Further, the spatial feature around the optical fiber cable may be a difference in sensitivity between each point on the optical fiber cable. In this case, the error calculation unit may calculate an error by using a difference between the output of the first nonlinear transformation unit and the output of the second nonlinear transformation unit, and a regularization term taking into consideration a difference in sensitivity between each point on the optical fiber cable.

Further, the spatial feature around the optical fiber cable may be low ranking of a spatial dimension of the first noise superimposed signal and the second noise superimposed signal. In this case, the first nonlinear transformation unit and the second nonlinear transformation unit may perform nonlinear transformation with a low rank constraint in the spatial dimension on the first noise superimposed signal and the second noise superimposed signal.

Further, the spatial feature around the optical fiber cable may be a difference in sensitivity between each point on the optical fiber cable, and low ranking of the spatial dimension of the first noise superimposed signal and the second noise superimposed signal. In this case, the error calculation unit may calculate an error by using a difference between the output of the first nonlinear transformation unit and the output of the second nonlinear transformation unit, and a regularization term taking into consideration a difference in sensitivity between each point on the optical fiber cable. Further, the first nonlinear transformation unit and the second nonlinear transformation unit may perform nonlinear transformation with a low rank constraint in the spatial dimension on the first noise superimposed signal and the second noise superimposed signal.

Further, the first noise superimposed signal may be a signal acquired by transforming the second noise superimposed signal by a predetermined noise suppression method. In this case, when the error becomes less than the threshold value, the extraction unit may extract the output of the second nonlinear transformation unit, as a noise suppression signal, and output the extracted noise suppression signal.

Further, the first noise superimposed signal and the second noise superimposed signal may be signals acquired by the DAS with respect to sound or vibration occurred in the same region by using optical fiber cables different from each other.

### <Hardware Configuration of Noise Suppression Apparatus According to Example Embodiment>

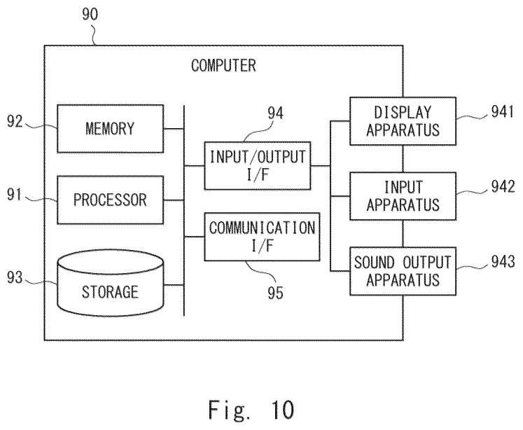

Subsequently, with reference to FIG. 10, a hardware configuration example of a computer that achieves the noise suppression apparatuses 10 and 20 described above will be described.

As illustrated in FIG. 10, a computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected by a data transmission path for transmitting and receiving data to and from one another.

The processor 91 is, for example, an arithmetic processing apparatus such as a central processing unit (CPU) or a graphics processing unit (GPU). The memory 92 is, for example, a memory such as a random access memory (RAM) or a read only memory (ROM). The storage 93 is, for example, a storage apparatus such as a hard disk drive (HDD), a solid state drive (SSD), or a memory card. Further, the storage 93 may be a memory such as a RAM or a ROM.

A program is stored in the storage 93. The program includes instructions (or a software code) for causing the computer 90 to perform, when loaded into the computer, one or more of functions of the noise suppression apparatuses 10 and 20 described above. Components of the noise suppression apparatuses 10 and 20 described above may be achieved by the processor 91 reading and executing the program stored in the storage 93. Further, a storage function of the noise suppression apparatuses 10 and 20 described above may be achieved by the memory 92 or the storage 93.

Further, the program described above can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The input/output interface 94 is connected to a display apparatus 941, an input apparatus 942, a sound output apparatus 943, and the like. The display apparatus 941 is an apparatus, such as a liquid crystal display (LCD), a cathode ray tube (CRT) display, or a monitor, that displays a screen associated to drawing data processed by the processor 91. The input apparatus 942 is an apparatus that accepts an operation input from an operator, and is, for example, a keyboard, a mouse, a touch sensor, or the like. The display apparatus 941 and the input apparatus 942 may be integrated and achieved as a touch panel. The sound output apparatus 943 is an apparatus, such as a speaker, that outputs sound associated to sound data processed by the processor 91.

The communication interface 95 transmits and receives data to and from an external apparatus. For example, the communication interface 95 communicates with an external apparatus via a wired communication path or a wireless communication path.

Although the present disclosure has been described with reference to the example embodiments, the present disclosure is not limited to the above-described example embodiments. Various changes that can be understood by a person skilled in the art within the scope of the present disclosure can be made to the configuration and details of the present disclosure. Then, each example embodiment can be combined with other example embodiments as appropriate.

Further, each drawing is merely illustrative of one or more example embodiments. Each drawing may be associated with one or more other example embodiments, rather than only one particular example embodiment. As those skilled in the art will appreciate, various features or steps described with reference to any one of the drawings may be combined with features or steps illustrated in one or more other drawings, for example, in order to generate an example embodiment not explicitly illustrated or described. All of the features or steps illustrated in any one of the drawings to describe the example embodiments are not necessarily essential, and some features or steps may be omitted. The order of the steps described in any of the drawings may be changed as appropriate.

An example advantage according to the above-described embodiment is to provide a noise suppression apparatus, a noise suppression method, and a non-transitory computer-readable medium that are capable of further suppressing noise of a noise superimposed signal.

Further, some or all of the above-described example embodiments may be described as the following supplementary notes, but are not limited thereto.

### Supplementary Note 1

A noise suppression apparatus including:
at least one memory configured to store instructions; and
at least one processor configured, by executing the instructions, to input a plurality of noise superimposed signals that are acquired by distributed acoustic sensing (DAS) using an optical fiber cable and on which noise is superimposed, extract a common feature of the plurality of input noise superimposed signals as a noise suppression signal in which noise is suppressed, and output the extracted noise suppression signal.

### Supplementary Note 2

The noise suppression apparatus according to supplementary note 1, wherein the at least one processor is configured, by executing the instructions, to extract a common feature of the plurality of noise superimposed signals as the noise suppression signal, in consideration of a spatial feature around the optical fiber cable.

### Supplementary Note 3

The noise suppression apparatus according to supplementary note 1, wherein
the plurality of noise superimposed signals are a first noise superimposed signal and a second noise superimposed signal, and
the at least one processor includes
a first processor configured, by executing the instructions, to input the first noise superimposed signal, and perform nonlinear transformation on the first noise superimposed signal using a parameter,
a second processor configured, by executing the instructions, to input the second noise superimposed signal, and perform nonlinear transformation on the second noise superimposed signal using the parameter,
a third processor configured, by executing the instructions, to calculate an error by using a difference between an output of the first processor and an output of the second processor, and
a fourth processor configured, by executing the instructions, to repeat updating the parameter until the error becomes less than a threshold value, extract the output of the first processor or the output of the second processor, as the noise suppression signal, when the error becomes less than the threshold value, and output the extracted noise suppression signal.

### Supplementary Note 4

The noise suppression apparatus according to supplementary note 3, wherein
a spatial feature around the optical fiber cable is a difference in sensitivity between each point on the optical fiber cable, and
the third processor is configured, by executing the instructions, to calculate the error by using the difference, and a regularization term taking into consideration the difference in sensitivity between each point on the optical fiber cable.

### Supplementary Note 5

The noise suppression apparatus according to supplementary note 3, wherein
a spatial feature around the optical fiber cable is low ranking of a spatial dimension of the first noise superimposed signal and the second noise superimposed signal, and
the first processor and the second processor are configured, by executing the instructions, to perform nonlinear transformation with a low rank constraint of a spatial dimension on the first noise superimposed signal and the second noise superimposed signal.

### Supplementary Note 6

The noise suppression apparatus according to supplementary note 3, wherein
a spatial feature around the optical fiber cable is a difference in sensitivity between each point on the optical fiber cable, and low ranking of a spatial dimension of the first noise superimposed signal and the second noise superimposed signal,
the third processor is configured, by executing the instructions, to calculate the error by using the difference, and a regularization term taking into consideration a difference in sensitivity between each point on the optical fiber cable, and
the first processor and the second processor are configured, by executing the instructions, to perform nonlinear transformation with a low rank constraint of a spatial dimension on the first noise superimposed signal and the second noise superimposed signal.

### Supplementary Note 7

The noise suppression apparatus according to supplementary note 3, wherein
the first noise superimposed signal is a signal acquired by transforming the second noise superimposed signal by a predetermined noise suppression method, and
the fourth processor is configured, by executing the instructions, to extract an output of the second processor, as the noise suppression signal, when the error becomes less than the threshold value, and output the extracted noise suppression signal.

### Supplementary Note 8

The noise suppression apparatus according to supplementary note 3, wherein the first noise superimposed signal and the second noise superimposed signal are signals that are acquired by the DAS with respect to sound or vibration occurred in the same region by using the optical fiber cables different from each other.

### Supplementary Note 9

A noise suppression method executed by a noise suppression apparatus, the noise suppression method including:
inputting a plurality of noise superimposed signals that are acquired by distributed acoustic sensing (DAS) using an optical fiber cable and on which noise is superimposed;
extracting a common feature of the plurality of noise superimposed signals as a noise suppression signal in which noise is suppressed; and
outputting the noise suppression signal.

### Supplementary Note 10

A program causing a computer to execute:
a procedure of inputting a plurality of noise superimposed signals that are acquired by distributed acoustic sensing (DAS) using an optical fiber cable and on which noise is superimposed;
a procedure of extracting a common feature of the plurality of noise superimposed signals as a noise suppression signal in which noise is suppressed; and
a procedure of outputting the noise suppression signal.

Note that, some or all of elements (for example, a configuration and a function) described in supplementary notes 2 to 8 being subordinate to supplementary note 1 may be subordinate to supplementary notes 9 and 10 due to the same dependencies as supplementary notes 2 to 8. Some or all of the elements described in any supplementary note may be applied to various pieces of hardware, software, a recording means for recording software, a system, and a method.

What is claimed is:

1. A noise suppression apparatus comprising:
at least one memory configured to store instructions; and
at least one processor configured, by executing the instructions, to input a plurality of noise superimposed signals that are acquired by distributed acoustic sensing (DAS) using an optical fiber cable and on which noise is superimposed, extract a common feature of the plurality of input noise superimposed signals as a noise suppression signal in which noise is suppressed, and output the extracted noise suppression signal.

2. The noise suppression apparatus according to claim 1, wherein the at least one processor is configured, by executing the instructions, to extract a common feature of the plurality of noise superimposed signals as the noise suppression signal, in consideration of a spatial feature around the optical fiber cable.

3. The noise suppression apparatus according to claim 1, wherein
the plurality of noise superimposed signals are a first noise superimposed signal and a second noise superimposed signal, and
the at least one processor includes
a first processor configured, by executing the instructions, to input the first noise superimposed signal, and perform nonlinear transformation on the first noise superimposed signal using a parameter,
a second processor configured, by executing the instructions, to input the second noise superimposed signal, and perform nonlinear transformation on the second noise superimposed signal using the parameter,
a third processor configured, by executing the instructions, to calculate an error by using a difference between an output of the first processor and an output of the second processor, and
a fourth processor configured, by executing the instructions, to repeat updating the parameter until the error becomes less than a threshold value, extract the output of the first processor or the output of the second processor, as the noise suppression signal, when the error becomes less than the threshold value, and output the extracted noise suppression signal.

4. The noise suppression apparatus according to claim 3, wherein
a spatial feature around the optical fiber cable is a difference in sensitivity between each point on the optical fiber cable, and
the third processor is configured, by executing the instructions, to calculate the error by using the difference, and a regularization term taking into consideration the difference in sensitivity between each point on the optical fiber cable.

5. The noise suppression apparatus according to claim 3, wherein
a spatial feature around the optical fiber cable is low ranking of a spatial dimension of the first noise superimposed signal and the second noise superimposed signal, and
the first processor and the second processor are configured, by executing the instructions, to perform nonlinear transformation with a low rank constraint of a spatial dimension on the first noise superimposed signal and the second noise superimposed signal.

6. The noise suppression apparatus according to claim 3, wherein
a spatial feature around the optical fiber cable is a difference in sensitivity between each point on the optical fiber cable, and low ranking of a spatial dimension of the first noise superimposed signal and the second noise superimposed signal,
the third processor is configured, by executing the instructions, to calculate the error by using the difference, and a regularization term taking into consideration a difference in sensitivity between each point on the optical fiber cable, and
the first processor and the second processor are configured, by executing the instructions, to perform nonlinear transformation with a low rank constraint of a spatial dimension on the first noise superimposed signal and the second noise superimposed signal.

7. The noise suppression apparatus according to claim 3, wherein
the first noise superimposed signal is a signal acquired by transforming the second noise superimposed signal by a predetermined noise suppression method, and
the fourth processor is configured, by executing the instructions, to extract the output of the second processor, as the noise suppression signal, when the error becomes less than the threshold value, and output the extracted noise suppression signal.

8. The noise suppression apparatus according to claim 3, wherein the first noise superimposed signal and the second noise superimposed signal are signals that are acquired by the DAS with respect to sound or vibration occurred in the same region by using the optical fiber cables different from each other.

9. A noise suppression method executed by a noise suppression apparatus, the noise suppression method comprising:
inputting a plurality of noise superimposed signals that are acquired by distributed acoustic sensing (DAS) using an optical fiber cable and on which noise is superimposed;
extracting a common feature of the plurality of noise superimposed signals as a noise suppression signal in which noise is suppressed; and
outputting the noise suppression signal.

10. A non-transitory computer-readable medium storing a program causing a computer to execute:
a procedure of inputting a plurality of noise superimposed signals that are acquired by distributed acoustic sensing (DAS) using an optical fiber cable and on which noise is superimposed;
a procedure of extracting a common feature of the plurality of noise superimposed signals as a noise suppression signal in which noise is suppressed; and
a procedure of outputting the noise suppression signal.
